(19) United States
(12) Patent Application Publication
(10) Pub. No.: US 2022/0414552 A1
(43) Pub. Date: Dec. 29, 2022

(54) CREATING COMMUNICATIONS CHANNELS DURING SCHEDULED OPERATIONS

(71) Applicant: PUT CORP., BURLINGTON, MA (US)

(72) Inventors: BRUCE WILLIAMS, PHOENIX, AZ (US); ANDRUS NOMM, IZMIR (TR); ALEX GREG MARDIKIAN, SCOTTSDALE, AZ (US)

(21) Appl. No.: 17/849,359

(22) Filed: Jun. 24, 2022

Related U.S. Application Data
(60) Provisional application No. 63/215,278, filed on Jun. 25, 2021.

(51) Int. Cl. G06Q 10/02; G06Q 10/06

(52) U.S. Cl. CPC G06Q 10/02; G06Q 10/0633

(57) ABSTRACT

A computer-implemented method of providing communication channels between actors to a job operation comprises the following steps: receiving, over at least one network connection, data corresponding to a job operation, wherein the job operation is carried out by a plurality of actors; reserving a number of communication channels over the at least one network connection, wherein the number of communication channels corresponds to the plurality of actors; assigning each of the plurality of actors to at least one node on the number of communication channels; and providing a temporary identifier to each of the plurality of actors at the at least one node, whereby each actor is in anonymous communication with each other actor across at least one communication channel.

### CROSS REFERENCE TO RELATED APPLICATION

This application claims benefit of U.S. Provisional Application Ser. No. 63/215,278 filed Jun. 25, 2021, the entire disclosure of which is incorporated herein by reference.

### FIELD OF THE DISCLOSURE

The present disclosure is generally related to communications networking and more particularly is related to providing anonymous communications channels to actors involved in an operation.

### BACKGROUND OF THE DISCLOSURE

Services for scheduling remote operations between actors are growing in popularity, from rideshare services, to food and shopping delivery, to pick-up services. For those services involving a plurality of actors, it is necessary to establish communication between the actors. Commonly, communication is performed through one or more methods, including in-app communications, push notifications, text messages, phone calls, or emails. For instance, services such as DoorDash, Uber, and Lyft enable drivers and customers to communicate within their respective apps, using text messages, or through voice calls. These services also provide updates to customers through email and push notifications.

In the case of text messages, phone calls, or email, it may be necessary to reveal personal information in order to establish communication between the actors. It is not always desirable to disclose this information to other actors. In some cases, drivers have been known to engage in prolonged unwanted contact with customers after an operation has been completed. In other cases, customers or drivers may wish to provide reviews and other feedback anonymously, which is made more difficult when their information is known by other actors.

Additionally, communication across each method may not always be effective. For instance, some users have in-app and push notifications silenced on their devices, and may not receive messages sent this way. Other users may not be able to respond to messages sent in visual or textual format, as they are driving or otherwise in an inappropriate setting. Still further, some users do not consider push notifications or text messages urgent enough to respond to in a timely manner. This can frustrate actors on all sides of an operation, as important details or other time-sensitive information is missed, lost, or delivered too late. Moreover, as additional actors are added to an operation to assist the functioning of the operation, it can be difficult to coordinate communication between each actor, whether individually between two actors or in larger parties of actors. Actors engaging in multiple operations may find it still more difficult to organize communications across each operation as well.

Thus, a heretofore unaddressed need exists in the industry to address the aforementioned deficiencies and inadequacies.

### SUMMARY OF THE DISCLOSURE

Embodiments of the present disclosure provide a computer-implemented system and method for providing communication channels between actors to a job operation. In this regard, one embodiment of such a method, among others, can be broadly summarized by the following steps: receiving, over at least one network connection, data corresponding to a job operation, wherein the job operation is carried out by a plurality of actors; reserving a number of communication channels over the at least one network connection, wherein the number of communication channels corresponds to the plurality of actors; assigning each of the plurality of actors to at least one node on the number of communication channels; and providing a temporary identifier to each of the plurality of actors at the at least one node, whereby each actor is in anonymous communication with each other actor across at least one communication channel.

The present disclosure can also be viewed as providing a computerized system for providing communication channels between actors to a job operation. Briefly described, in architecture, one embodiment of the system, among others, can be implemented as follows. A computerized system for providing communication channels between actors to a job operation includes a plurality of actor electronic devices, each corresponding to an actor carrying out a job operation. The plurality of actor electronic devices is in communication with one another over at least one network connection. A network electronic device is in communication with the plurality of actor electronic devices over the at least one network connection. The network electronic device has a processor and computer-readable memory. The network electronic device is configured to: receive data corresponding to the job operation carried out by the plurality of actors; reserve a number of communication channels over the at least one network connection, wherein the number of communication channels corresponds to the plurality of actors; assign each of the plurality of actors to at least one node on the number of communication channels; and provide a temporary identifier to each of the plurality of actors at the at least one node, whereby each actor is in anonymous communication with each other actor across at least one communication channel.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a flowchart illustrating a computer-implemented method of providing communication channels between actors to a job operation, in accordance with one exemplary embodiment of the present disclosure.

FIG. 2 is a diagrammatic illustration of the communication channels and actors, in accordance with one exemplary embodiment of the present disclosure.

FIG. 3 is a block diagram showing a plurality of communications channels between two actors, in accordance with one exemplary embodiment of the present disclosure.

FIG. 4 is a block diagram showing the computer-implemented method of FIG. 1 in operation, in accordance with one exemplary embodiment of the present disclosure.

### DETAILED DESCRIPTION

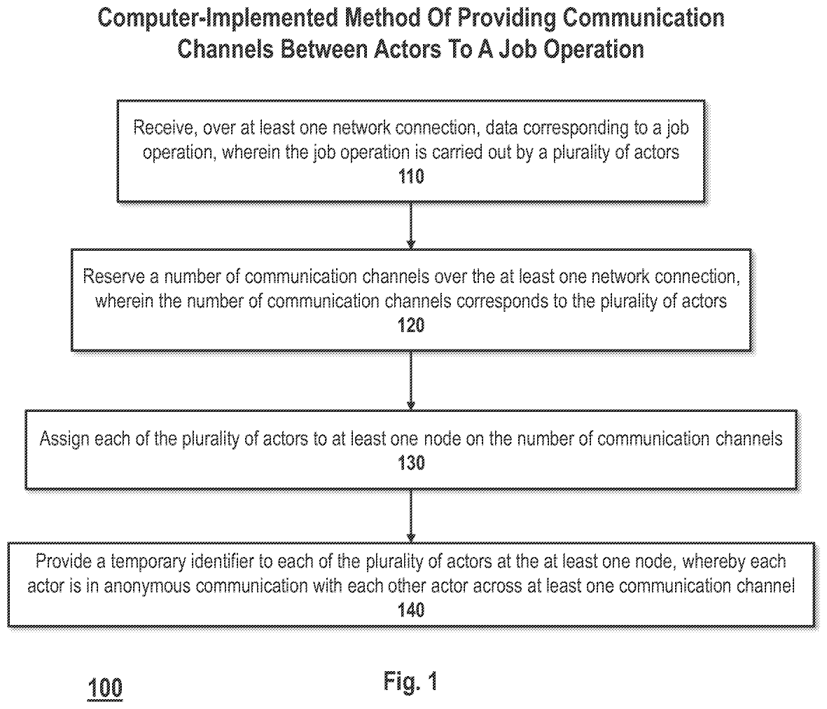

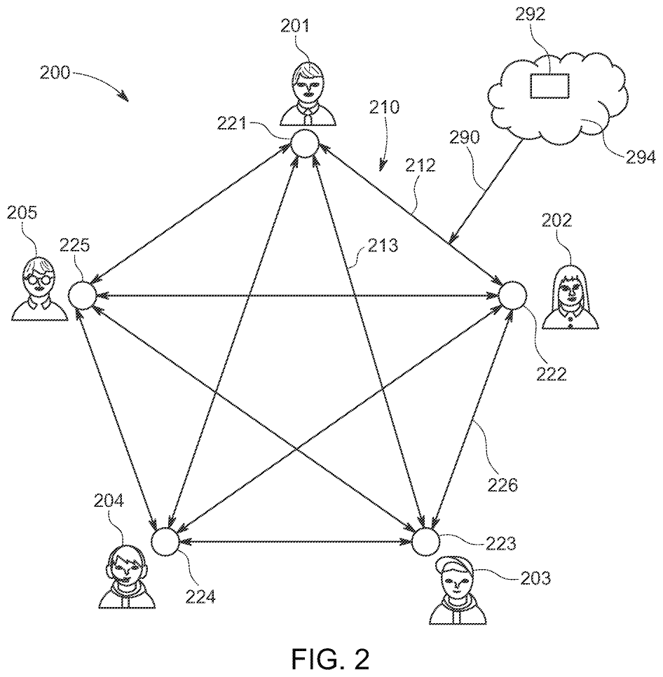

FIG. 1 is a flowchart 100 illustrating a computer-implemented method of providing communication channels between actors to a job operation, in accordance with one exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.The method may further include any other features, components, or functions disclosed relative to any other figure of this disclosure. The method may be better understood with reference to FIG. 2, below. FIG. 2 is a diagrammatic illustration of the communication channels 210 and actors 201-205 described within the method, in accordance with one exemplary embodiment of the present disclosure. FIG. 2 may be understood as a computerized system 200 for providing communication channels between actors to a job operation operating in accordance with the method of FIG. 1. FIGS. 1 and 2 are discussed together may be understood to include like or shared aspects.

Step 110 of the method includes receiving, over at least one network connection 290, data corresponding to a job operation 292, wherein the job operation is carried out by a plurality of actors 201-205. The at least one network connection 290 may be any suitable type and number of network connections, including Internet, Bluetooth®, Wi-Fi, Near-Field Communication, intranet, wired network, radio, satellite, cellular, and other network connections. In one example, the data corresponding to the job operation 292 may be generated by one or more actors 201-205, for instance, a consumer actor 202 hiring a driver actor 205 to perform a job. In one example, the data corresponding to the job operation 292 may be communicated over the at least one network connection to the plurality of actors 201-205 using a connected server or other processing device.

The job operation 292 may be any task, series of tasks, or steps performed by at least one actor 201-205 on behalf of at least another actor 201-205. For instance, the job operation 292 may include a pick-up operation where a consumer actor 202 requests a driver actor 205 to pick up a load and deliver it to a refuse station or a customer of the consumer actor 202. As another example, the job operation 292 may include a request to pick up a passenger and deliver them to a location, or to pick up a meal, grocery delivery, or other parcel, and deliver it to the consumer actor 202. It should be understood that the job operation 292 may include any type of operations requested and enacted between a plurality of parties, including delivery operations, requests for the performance of written, technical, and artistic services, and the like. It should further be understood that the job operation 292 may include job operations performed, in whole or in part, by computers, persons, or some combination thereof. Therefore, a job operation 292 may include computer-executable tasks, including machine language operations, portions of code, and the like. Data corresponding to a job operation 292 may include any information, whether human-readable, machine-readable, portions of computer code, or the like, that furthers the ability of an actor 201-205 to perform the job operation 292. Data corresponding to the job operation 292 may include instructions for the operation to be completed, details relevant to the operation, logistical data, such as inventory and tracking information, and computer code for scheduling the job operation 292 within the system 200.

The actors 201-205 may include any number and type of people, services, computer programs, bots, or other entities capable of assisting with one or more aspects of a job operation 292. In one example, the actors 201-205 may be people playing one or more roles in the execution of the job operation. For instance, the actors may include a lead actor 201, consumer actor 202, helper actor 203, support actor 204, and driver actor 205. For simplicity of discussion, the remainder of the disclosure may refer to an exemplary embodiment wherein the job operation 292 is a delivery-related operation, and the actors 201-205 are human operators. However, it should be understood that the disclosure may refer to and incorporate any other type and combination of job operations 292 and actors 201-205 described above.

A lead actor 201 may be an actor tasked with finding or identifying job operations 292 and performing functions related to execution of the job operation 292. For example, lead actors 201 may coordinate the execution of job operations 292 within an organization, for instance, coordinating or executing the purchase and packing of an item in a store or restaurant. The lead actor 201 may perform operations to ready a load for transport and delivery.

A consumer actor 202 may be a person who requests or creates a job operation 292. For instance, this person may request a load to be removed from their possession and delivered to a refuse station. A consumer actor 202 may provide details required for completion of the job operation 292, such as the load, pick-up location, destination, and the like. A driver actor 205 may be a person who executes at least a portion of the direct objective of the job operation 292. For instance, this may include a driver of a vehicle who may pick up the consumer actor 202's load and transport it to the desired destination. Driver actors 205 may execute only a portion of the job operation 292, for instance, to pick up and deliver a load to an intermediate location or a second driver actor 205.

A support actor 204 may be an actor responsible for providing auxiliary support to the consumer actor 202 and driver actor 205. For instance, a support actor 204 may answer a consumer actor 202's questions, provide clarifying details to driver actors 205 and lead actors 204, and maintain an administrative overview of the job operation 292. In one example, the support actor 204 may contact any of the other actors 201-205 to ensure timely and smooth completion of the job operation 292.

A helper actor 203 may be an actor responsible for providing direct assistance to a driver actor 205 in completing one or more aspects of the job operation 292. In one example, a helper actor 203 may assist a driver actor 205 in lifting and securing a heavy load. In another example, a helper actor 203 may assist a driver actor 205 in navigating through a location, recording information, communicating with other actors 201-205, and the like.

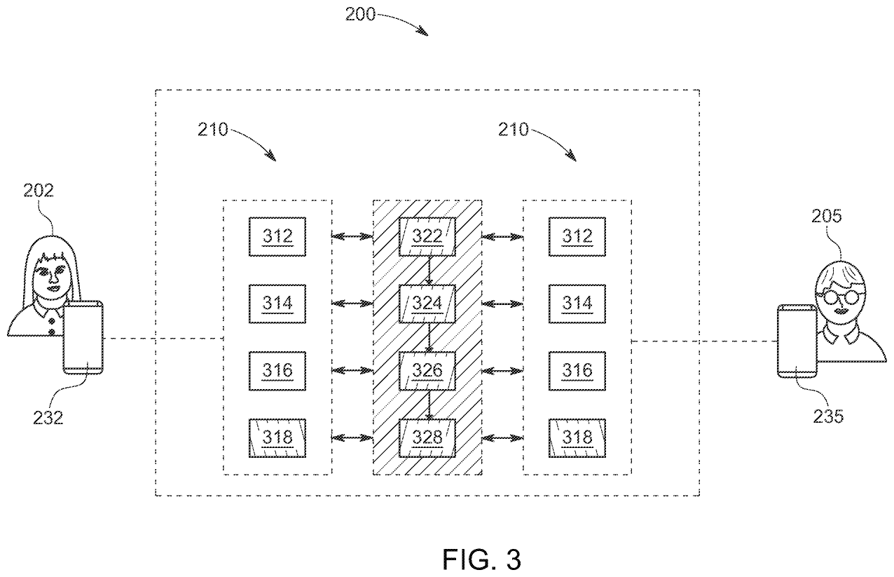

The data corresponding to the job operation 292 may be received by a computer, server, or other network electronic device 294 in communication with the at least one network connection 290. The network electronic device 294 may include any suitable computing devices capable of receiving job operation data 292 and communicating the data 292 to the plurality of actors 201-205. In one example, this may include a central computer or server in communication with each actor 201-205. The network electronic device 294 may include any necessary operating components, such as a processor, computer-readable memory, networking connections, a power supply, and the like, which are not shown for simplicity of illustration. In one example, the network electronic device 294 may communicate the data corresponding to the job operation 292 to one or more actor electronic devices 232, 235 used by each actor 201-205, which may be any personal computer devices, including cellular phones, smartphones, tablets, laptops, integrated automotive devices, desktop computers, smartwatches, and the like. For simplicity of illustration, the actor electronic devices 232, 235 are not shown in FIG. 2, but are illustrated in operation in FIG. 3, below. It should be understood that each actor 201-205 may operate an actor electronic device 232, 235 as is known to receive, access, manipulate, and/or send data 292 corresponding to the job operation. Data 292 may be communicated over the at least one network 290 between any of the actor electronic devices 232, 235 and the network electronic device, for instance, as a central server coordinating communications.

Step 120 includes reserving a number of communication channels 210 over the at least one network connection 290, wherein the number of communication channels 210 corresponds to the plurality of actors 201-205. The communication channels 210 may include any suitable number and type of channels, for instance, voice channels, SMS channels, push notification channels, and the like. In one example, the number of channels may correspond to only a portion of the plurality of actors 201-205, for instance, only actors who are likely to be in communication with one another. In another example, the network electronic device 294 may reserve every available type of communication channel 210 for each actor 201-205. In another example, the network electronic device 294 may reserve only certain types of communication channels 210 for each actor 201-205. In another example, the network electronic device 294 may reserve less than every available type of communication channel 210 for at least one actor 201-205. In one example, the network electronic device 294 may create at least one channel 212 for each connection between actors 201-205. For instance, when 5 actors 201-205 are involved, each actor may be in connection with each of the 4 other actors. There may be at least 10 unique channels created. The number of channels 212 created may correspond to the equation:

N_C=(A)*(n−1)!,

Where N_C is the number of channels created, n is the number of actors, and A is the number of channel types desired. In another example, channels 212 may only be created between certain actors, such as a driver actor 205 and a consumer actor 202. In yet another example, certain types of channels 212 may be created between particular actors. For instance, an SMS channel may be created between a consumer actor and a driver actor 202, 205, while a telephone channel may be created between a driver actor 205 and a support actor 204.

Step 130 includes assigning each of the plurality of actors 201-205 to at least one node 221-225 on the number of communication channels 210. FIG. 2 illustrates channels 210 reserved between particular actors 201, 202, 203 for exemplary purposes. For instance, a communications channel 212 between a lead actor 201 and a consumer actor 202 may be reserved to allow the lead and consumer actors 201, 202 to communicate about the purchase and packaging of a load. A communications channel 226 between a consumer actor 202 and a helper actor 203 may allow the actors 202, 203 to communicate about logistics details related to delivery of the load. A communications channel 213 between a lead actor 201 and a helper actor 203 may allow the actors 201, 203 to communicate about logistics related to pick-up of the load. Each node 221-225 may correspond to a particular actor. For instance, node 221 is illustrated in FIG. 2 as corresponding to lead actor 201, node 222 is illustrated as corresponding to consumer actor 202, node 223 is illustrated as corresponding to helper actor 203, node 224 is illustrated as corresponding to support actor 204, and node 225 is illustrated as corresponding to driver actor 205. In one example, each node 221-225 may correspond to each actor 201-205 for all types of communication. For instance, lead actor 201 may have a first node 221 through which SMS, push notifications, email, phone calls, and the like are directed. In another example, lead actor 201 may have a first node 221 through which SMS communications are directed, and a second node (not shown) through which a subsequent type of communications is directed, and so on.

Step 140 includes providing a temporary identifier to each of the plurality of actors 201-205 at the at least one node 221-225, whereby each actor 201-205 is in anonymous communication with each other actor across at least one communication channel 210. The temporary identifier may be an identifier that does not correspond to the actual contact information of the actors 201-205. For instance, the system 200 may establish an SMS communications line between actors 201, 202 using SMS numbers temporarily reserved for the particular job operation 292. The temporary SMS numbers may not actually belong to either actor 201, 202, but may be temporarily assigned to each actor 201, 202 to allow the actors 201, 202 to communicate with one another using the temporary SMS numbers. By providing the temporary identifier, the actors 201, 202 may retain relative anonymity when communicating; neither actor 201, 202 will know the other's permanent SMS number or other information. The temporary identifier may correspond to any of the channels 212 and nodes 221-225, including SMS channels, telephone channels, push notification channels, email channels, and the like. Each actor 201-205 may use the temporary channel and identifier to anonymously or semi-anonymously communicate with the other actors 201-205.

The system 200 may include a plurality of actor electronic devices, illustrated in FIG. 3 as mobile devices 232, 235, but which may include any number and type of devices belonging to each actor 201-205. The plurality of actor electronic devices 232, 235 may correspond to an actor carrying out a job operation. The plurality of actor electronic devices 232, 235 are in communication with one another over the at least one network connection 290. The network electronic device 294 is in communication with the plurality of actor electronic devices 232, 235 over the at least one network connection 290. The network electronic device 294 is configured to perform any of the steps of the method of FIG. 1, including being configured to: receive data corresponding to the job operation carried out by the plurality of actors; reserve a number of communication channels over the at least one network connection, wherein the number of communication channels corresponds to the plurality of actors; assign each of the plurality of actors to at least one node on the number of communication channels; and provide a temporary identifier to each of the plurality of actors at the at least one node, whereby each actor is in anonymous communication with each other actor across at least one communication channel.

FIG. 3 is a block diagram showing a plurality of communications channels 210 between two actors 202, 205, in accordance with one exemplary embodiment of the present disclosure. The system 200 of FIG. 2 is partially illustrated, including the consumer actor 202, driver actor 205, consumer actor electronic device 232, driver actor electronic device 235, and communications channels 210. In particular, a plurality of exemplary types of channels are shown, including push notification channels 312, SMS channels 314, e-mail channels 316, and app chat channels 318. After the method of FIG. 1 has been performed, the system 200 may perform a number of steps 322-328 in order to establish successful communication between the actors 202, 205. It should be understood that any of steps 322-328 may be performed, in whole or in part, and in any order suitable to establish successful communication. It should also be understood that these steps 322-328 may be performed between any type and number of actors 201-205. The actors 202, 205 shown in FIG. 3 are meant to be exemplary, and not limiting in any respect.

One actor, for example the consumer actor 202, may seek to communicate with another actor, for example the driver actor 205. In one example, consumer actor 202 may operate the consumer actor electronic device to initiate the communication.

In step 322, the system 200 may automatically determine the optimal type of communications channels 210 to connect the actors 202, 205. For example, the system 200 may determine that communication is most likely to be successful when a driver actor 202 communicates by SMS channels 314 and a consumer actor 205 communicates by push notification channels 312. The system 200 may consider a number of factors in making this determination, including the content of the communication, the time the communication was sent, the frequency of communications, the communications history between the actors 202, 205, the personal communications history of each individual actor 202, 205, and the history of response by either actor 202, 205. For instance, the content of the communication may indicate an urgent message best addressed by SMS communication 314 or an administrative message best organized within the app chat channels 318. The time the communication was sent may affect the channel 210 if the communication is during a do-not-disturb period, in which case the communication may go through an email 316 or app chat channel 318. The frequency of communications may indicate that SMS or app chat channels 314, 318 are appropriate, for instance, if the communications are in rapid succession. And the communications history between and by the actors 202, 205 may indicate that an actor 202, 205 is more likely to respond to a particular channel 210, depending on the circumstance. The system 200 may make this determination based on historical data, on content read by computer vision or machine learning, and by algorithms for escalating a message to an appropriate channel. For instance, if the consumer actor 202 repeats the same message multiple times through one channel 210, the system 200 may determine that the message should be delivered through a different channel in order to reach the driver actor 205. In one example, if the driver actor 205 is not responding to an email channel 316 after several attempts, the system 200 may determine that the message should be routed through an SMS, push notification, or app chat channel 314, 312, 318.

In step 324, the system 200 may select a channel 210 based on the determination made in step 322. In one example, the system 200 may select a plurality of channels 210, or may operate in a recursive loop beginning with step 322 to reassess the appropriate channel 210. The selected channel 210 may be selected for one or more actors 202, 205. For instance, if the driver actor 205 begins a message using the SMS channel 314, the system 200 may not select a different channel for the driver actor 205, but may select an appropriate channel for the consumer actor 202. In another example, the system 200 may select a different channel for the driver actor 205 in order to facilitate more effective communication. In this way, the system 200 may deliver the data corresponding to the job operation 292 to at least one recipient actor 201-205 using at least one type 312-318 of communications channel 210. Then, the system 200 may select, in response to the at least one recipient actor 201-205, a different type 312-318 of communications channel 210 for subsequent communications.

In step 326, the system 200 may establish secure communications between the selected channels 210. For example, the system 200 may perform a check to ensure that the messages are being delivered over an encrypted channel or are being delivered to the correct recipient. In one example, communication channels 210 may be secured from both sides and may not allow the actors 201-205 to view personal information on the other actors 201-205. The system 200 may know the true, permanent identifying information for any actor parties 201-205, but may assign temporary identities as described relative to FIG. 1, above.

In step 328, a job chat engine may handle and execute the communications between the actors 202, 205. This may include receiving and delivering messages, recording communication data, and beginning the recursive process.

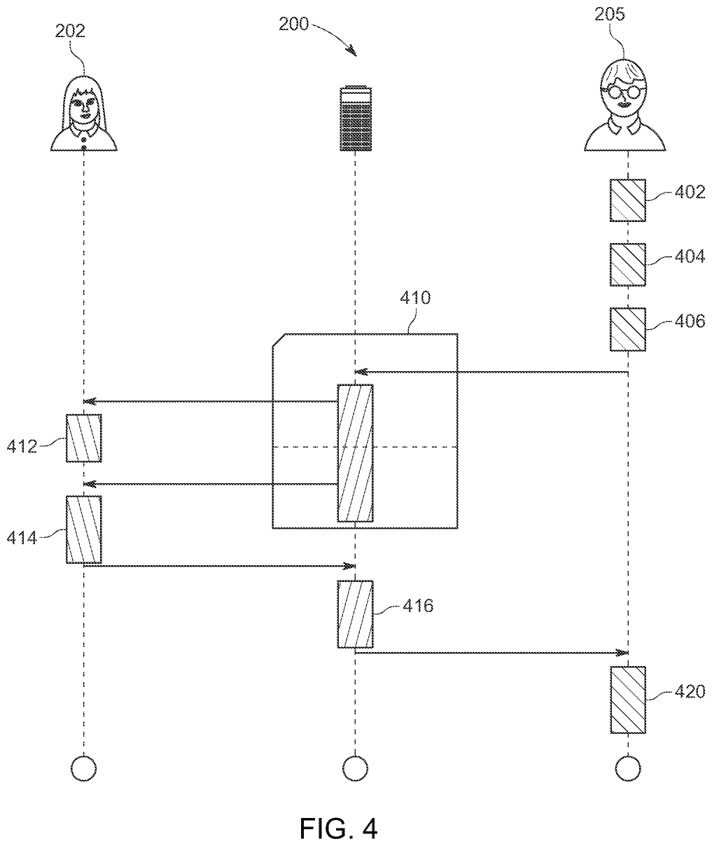

FIG. 4 is a block diagram showing the computer-implemented method of FIG. 1 in operation, in accordance with one exemplary embodiment of the present disclosure. FIG. 4 illustrates an exemplary scenario where a driver actor 205 is attempting to communicate with a consumer actor 202, but the consumer actor 202 is not responding.

In block 402, the driver actor 205 has accepted the job operation. In block 404, the driver actor 205 has begun execution of the job operation.

In block 406, the driver actor 205 has encountered an issue during the execution of the job operation that requires communication with the consumer actor 202. The driver actor 205 may enter an app chat channel to send a message. In block 410, the driver actor 205 may attempt to contact the consumer actor 202 through the app chat channel. In block 412, the communication was sent to the consumer actor 202 as a push notification, but no response was received for a period of time. Accordingly, again in block 410, the system 200 attempted to contact the consumer actor 202 by sending an SMS notification. In the example, the SMS notification was an escalated communications channel determined to effect a timely response. In practice, the escalated communications channel may be any one or more channels discussed relative to FIGS. 1-3, above. In the example, the SMS notification caused the consumer actor 202 to respond via SMS to the driver actor 205's message, shown in block 414. In block 416, the SMS message is received by the system 200 and converted to a message in the app chat channel. In block 420, the driver actor 205 receives the message in the app chat channel and proceeds with execution of the job.

It should be understood from this example that this escalated communication between the driver actor 205 and the consumer actor 202 is an improvement over the current art. In one regard, the communication is more effective in circumstances where a single channel may not be sufficient to warrant a response from one or more actors. The system 200 determines an appropriate channel to begin with, waits an appropriate amount of time for a response, and then reassesses the circumstance for the next best communication channel. In the example, a different channel was selected, and the consumer actor 202 responded. In another regard, this process was computer-implemented such that it could be executed without constant attention from the driver actor 205. This computer-implemented process represents an improvement in computer-implemented communications protocols, since it describes an escalating method for determining optimal communications channels between actors. In another regard, the process was performed anonymously across the number of communications channels. While existing services such as DoorDash provide anonymous or semi-anonymous communications channels to actors involved in an operation, they do not disclose a computer-implemented process for escalating those anonymous communications to receive a response.

It should be emphasized that the above-described embodiments of the present disclosure are merely possible examples of implementations, merely to set forth for a clear understanding of the principles of the disclosure. Many variations and modifications may be made to the above-described examples of the disclosure without departing substantially from the spirit and principles of the disclosure. All such modifications and variations are intended to be included herein within the scope of this disclosure and the present disclosure and protected by the following claims.

What is claimed is:

1. A computer-implemented method of providing communication channels between actors to a job operation, comprising the steps of:
receiving, over at least one network connection, data corresponding to a job operation, wherein the job operation is carried out by a plurality of actors;
reserving a number of communication channels over the at least one network connection, wherein the number of communication channels corresponds to the plurality of actors;
assigning each of the plurality of actors to at least one node on the number of communication channels; and
providing a temporary identifier to each of the plurality of actors at the at least one node, whereby each actor is in anonymous communication with each other actor across at least one communication channel.

2. The method of claim 1, wherein the plurality of actors is selected from the set of:
lead actors, consumer actors, helper actors, support actors, and driver actors.

3. The method of claim 1, wherein a type of communication channel reserved is selected from the set of: voice, push notification, SMS, e-mail, and app chat channels.

4. The method of claim 3, wherein every type of communication channel from the set is reserved for each actor.

5. The method of claim 3, wherein, for at least one actor, less than every type of communication channel from the set is reserved.

6. The method of claim 5, further comprising the step of determining an optimal communication channel type between at least two of the plurality of actors.

7. The method of claim 6, wherein the optimal communication channel type is determined using at least one from the set of: a time a communication is sent, a frequency of multiple communications, a history of multiple communications between two or more actors, a history of an individual actor's communications, and a response history of an actor.

8. The method of claim 3, further comprising the steps of:
delivering the data corresponding to the job operation to at least one recipient actor using at least one type of communication channel; and
selecting, in response to the at least one recipient actor, a different type of communication channel for subsequent communications.

9. The method of claim 1, wherein the number of communication channels reserved is determined as the product of the number of types of communication channels desired and the factorial of one less than a number of the plurality of actors.

10. The method of claim 1, wherein the number of communications channels corresponds to only a portion of the plurality of actors.

11. A computerized system for providing communication channels between actors to a job operation, comprising:
a plurality of actor electronic devices, each corresponding to an actor carrying out a job operation, the plurality of actor electronic devices in communication with one another over at least one network connection; and
a network electronic device in communication with the plurality of actor electronic devices over the at least one network connection, the network electronic device having a processor and computer-readable memory, and wherein the network electronic device is configured to:
receive data corresponding to the job operation carried out by the plurality of actors;
reserve a number of communication channels over the at least one network connection, wherein the number of communication channels corresponds to the plurality of actors;
assign each of the plurality of actors to at least one node on the number of communication channels; and
provide a temporary identifier to each of the plurality of actors at the at least one node, whereby each actor is in anonymous communication with each other actor across at least one communication channel.

12. The system of claim 11, wherein the plurality of actors is selected from the set of: lead actors, consumer actors, helper actors, support actors, and driver actors.

13. The system of claim 11, wherein a type of communication channel reserved is selected from the set of: voice, push notification, SMS, e-mail, and app chat channels.

14. The system of claim 13, wherein every type of communication channel from the set is reserved for each actor.

15. The system of claim 13, wherein, for at least one actor, less than every type of communication channel from the set is reserved.

16. The system of claim 15, wherein the network electronic device is further configured to: determine an optimal communication channel type between at least two of the plurality of actors.

17. The system of claim 16, wherein the optimal communication channel type is determined using at least one from the set of: a time a communication is sent, a frequency of multiple communications, a history of multiple communications between two or more actors, a history of an individual actor's communications, and a response history of an actor.

18. The system of claim 13, wherein the network electronic device is further configured to:
deliver the data corresponding to the job operation to at least one recipient actor using at least one type of communication channel; and
select, in response to the at least one recipient actor, a different type of communication channel for subsequent communications.

19. The system of claim 11, wherein the number of communication channels reserved is determined as the product of the number of types of communication channels desired and the factorial of one less than a number of the plurality of actors.

20. The system of claim 11, wherein the number of communications channels corresponds to only a portion of the plurality of actors.
